(19) United States
(12) Patent Application Publication
(10) Pub. No.: US 2018/0138478 A1
(43) Pub. Date: May 17, 2018

(54) ALLEVIATING EXPLOSION PROPAGATION IN A BATTERY MODULE

(71) Applicant: ANHUI XINEN TECHNOLOGY CO., LTD., Anqing Anhui (CN)

(72) Inventor: John R. Chan, Fremont, CA (US)

(21) Appl. No.: 15/421,794

(22) Filed: Feb. 1, 2017

Related U.S. Application Data
(60) Provisional application No. 62/421,956, filed on Nov. 14, 2016.

(51) Int. Cl. H01M 2/10

(52) U.S. Cl. CPC H01M 2/1094; H01M 2220/20; H01M 2/1077

(57) ABSTRACT

Disclosed is a technique for alleviating explosion propagation from one cell to another cell in a battery module. Cell explosion propagation is contained in an opening adjacent to cells, directed down a channel isolated from other cells, and released from the enclosure. A perforated region of an insulation region adjacent to a pole of a cells opens in response to the explosion, releasing explosion emissions down the channel. Gaseous pressure and heat generated by the exploding cell is released through a fracture seal or a flexible seal at the edge of the enclosure and/or a rupture of the cover at a prefabricated fracture line.

This application claims the benefit of U.S. Provisional Patent Application No. 62/421,956, titled “Prevention of Single Cell Explosion Propagation in a Battery Pack for Electric Vehicle” and filed on Nov. 14, 2016, which is incorporated by reference herein in its entirety.

### TECHNICAL FIELD

At least one embodiment of the technique introduced herein relates to energy storage, and more particularly, to alleviating explosion propagation in a battery module.

### BACKGROUND

Battery cell failures can result from, for example, design flaws, manufacturing flaws, and stress events. Design flaws in a battery cell can include, for example, flaws in the electrode, separator, or electrolyte design. Stress events can include, for example, charging at a sub-freezing temperature, vibrations, or a collision. Battery cell failures can result in, for example, a mild short or thermal runaway. A mild short can cause elevated self-discharge where heat buildup is minimal because power discharge is low. However, if enough metallic particles converge in one spot, a sizable current can begin to flow between electrodes of the cell, and the spot can heat up and weaken. Heat buildup can damage an insulation layer in a battery cell and cause an electrical short. Thermal runway can result in a battery cell temperature quickly reaching 500° C. (932° F.), at which point the cell can catch fire or explode. Thermal runaway is also known as “venting with flame” and “rapid disassembly” by some industry professionals.

Battery cells in a battery module, such as may be used in an electric vehicle, are typically in close proximity to one another. An explosion of one cell in a battery module can propagate to other cells in the battery module, causing the other cells to become thermally unstable or explode. An explosion can propagate to multiple cells or an entire battery pack in a chain reaction, resulting in catastrophic damage to the battery module and anything within proximity of the battery module.

### BRIEF DESCRIPTION OF THE DRAWINGS

FIG. 1 shows a perspective view of a battery module.

FIG. 2 shows a cross-sectional view of the battery module, exposing internal components of the battery module.

FIG. 3 shows a perspective cross-sectional view of the battery module.

FIG. 4 shows an enlarged cross-sectional perspective view of the battery module.

FIG. 5 shows an exploded view of a top cover construction for the battery module.

FIG. 6A shows an exploded view of a bottom cover construction for the battery module.

FIG. 6B shows an exploded view of a bottom cover construction for the battery module.

### DETAILED DESCRIPTION

In this description, references to “an embodiment”, “one embodiment” or the like, mean that the particular feature, function, structure or characteristic being described is included in at least one embodiment of the technique introduced here. Occurrences of such phrases in this specification do not necessarily all refer to the same embodiment. On the other hand, the embodiments described are not necessarily mutually exclusive.

Introduced here is a technology for alleviating explosion propagation from one cell to another in a battery module of a type that may be used in an electric vehicle, stationary power storage, and other possible applications. The battery module includes a plurality of cells encased (enclosed) by a top cover, bottom cover, and sidewalls. An opening extends from a pole of at least one cell to a perforated region of an insulation layer within the battery module. A channel on an opposite side of the insulation layer as the opening extends from the perforated region to a fracturable or flexible seal between the top cover and a sidewall. In the event that a cell explodes, the perforated region of the insulation layer ruptures, releasing explosion emissions into the channel. Adjacent perforated regions in line with adjacent cells are not ruptured, so explosion emissions do not come in contact with adjacent cells. Since explosion emissions (e.g., molten chemical content of cell) are contained in the channel and do not contact adjacent cells, adjacent cells may be prevented from undergoing thermal runaway and exploding. A cell explosion can cause the fracturable or flexible seal to rupture, or deflect outward, releasing explosion emissions out of the battery module. Since the fracturable or flexible seal is at a side of the battery module, explosion emissions can be directed sideways (e.g., away from passengers of an electric vehicle).

A battery pack consists of battery modules with each battery module having several, and up to thousands, of battery cells. A battery module can include battery cells of various types and configuration formats. These battery cells can be closely packed together to achieve a high packing density in an enclosure. At any point in time one of the battery cells can become defective (e.g., due to a design/manufacturing flaw or stress event). The defective cell can lead to thermal runaway that results in an explosion event.

As a precursor to an explosion, a battery cell emits hot gaseous fumes through a fracture line or gas escape prefabricated at or near a pole cap. The fumes and debris, if not contained or directed, spread to neighboring cell(s) due to high packing density of cells in a battery module. Neighboring cell(s) ignite from spreading fumes and/or debris, leading to a chain reaction explosion within a time frame (e.g., seconds). After the gaseous fume emission and with higher temperature (e.g., from thermal runaway), the cell explodes, emitting more fumes and ejecting molten chemical content as well as debris of the cell.

In an enclosure of conventional battery modules, a structure or component parts above an exploded cell deflects hot debris down back to the cells neighboring the exploded cell. When the hot debris falls on the neighboring cells, the neighboring cells ignite, explode, and spread hot gas and debris from one cell to another, resulting a catastrophic explosion. When multiple or potentially all of the cells in a battery pack explode due to explosion propagation, the result can be catastrophic, resulting in substantial damage of the vehicle, the surrounding properties, or loss of life. Cell explosion propagation resulting in chain reaction catastrophic explosion can occur in most if not all modern electric vehicles.

The technique disclosed herein alleviates explosion propagation in a battery module by isolating explosion emissions from neighboring cells. The battery module includes a plurality of cells encased by a top cover, bottom cover, and sidewalls. Embodiments include structures for directing materials generated from an explosion event of a cell away from neighboring cells. For example, a flexible lip seal on a sidewall of a battery module is used to enable fumes and debris to escape as well as isolate fumes and debris from other cells. A relief space having an inert gas (e.g., argon) can be used as a pathway to direct fumes and debris up to the flexible lip seal. The inert gas deprives any fumes and debris of oxygen and does not react with lithium found in many types of battery cells. Embodiments include structures for relieving pressure by including a fracture line at a designated location (e.g., fabricated at a bottom of battery module) to direct explosion emissions away from passengers of an electric vehicle (e.g., downward). For example, a prefabricated fracture line is used to rupture a bottom cover of the battery module to relieve pressure. In an embodiment, the battery module includes both the flexible lip seal on the side wall and the prefabricated fracture line on the bottom cover. Note that while embodiments include vehicle applications, the disclosed technique is not limited to vehicles and can potentially be implemented in various applications.

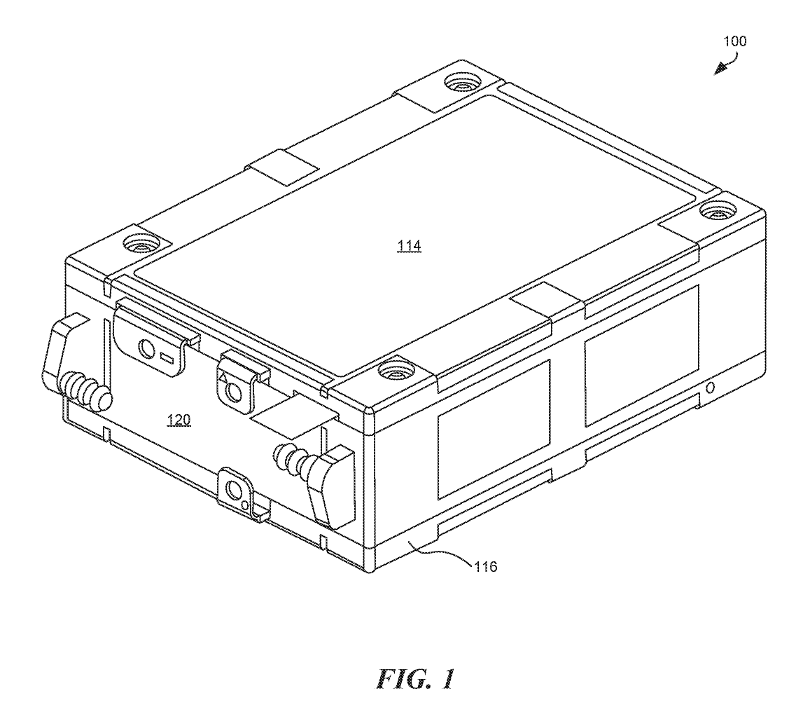

FIG. 1 shows a perspective view of the battery module 100. Several battery modules can be grouped into a battery pack (not shown) and used, for example, in an electric vehicle. The battery module 100 includes a plurality of cells (not shown in FIG. 1) and interconnects that provide electrical conductivity between cells. The cells can be configured in series, parallel or a combination of both, to deliver the desired voltage, capacity, or power density. Cells among the plurality of cells can be identical or distinct. The cells can be, for example, electrochemical cells (e.g., lithium ion, lead-acid, nickel metal hydride, molten salt, etc.).

The battery module 100 can include a cooling mechanism, temperature sensor, voltage sensor, or any combination thereof. The cooling mechanism can be used, for example to cool overheating cells. The temperature sensor can be used, for example, to detect overheating (e.g., thermal runaway) during operation, charging, and discharging. The voltage sensor can detect voltages among cells and transmit voltage data to a battery management system (BMS).

The battery module 100 includes a top cover 114, bottom cover 116, and at least one sidewall 120 (e.g., four sidewalls). The term “top” in this context (e.g., as in “top cover”) refers to an object (or portion of an object) that is to be positioned adjacent to (or closest to) the vehicle cabin of the vehicle in which it is installed. The term “bottom” in this context (e.g., as in “bottom cover”) refers to an object (or portion of an object) that is to be positioned opposite from (or farthest from) the vehicle cabin. Explosion emissions can be directed away from the vehicle cabin through a fracture line of the bottom cover and/or through a fracturable or flexible seal between the top cover 114 and the sidewall 120.

A fracturable or flexible seal (not shown in FIG. 1) can be used to attach an outer edge of a lower surface of the top cover 114 to an upper surface of sidewall 120. The fracturable or flexible seal can be used to attach an outer edge of an upper surface of the bottom cover 116 to a bottom surface of sidewall 120. The fracturable or flexible seal can be used to direct explosive emissions in a direction in line with the fracturable or flexible seal and a channel (not shown in FIG. 1) within the battery module 100. In an embodiment, the channel and fractural or flexible seal are used to direct explosion emissions away from passengers of an electric vehicle. Various components and configurations of the battery module 100 are described below.

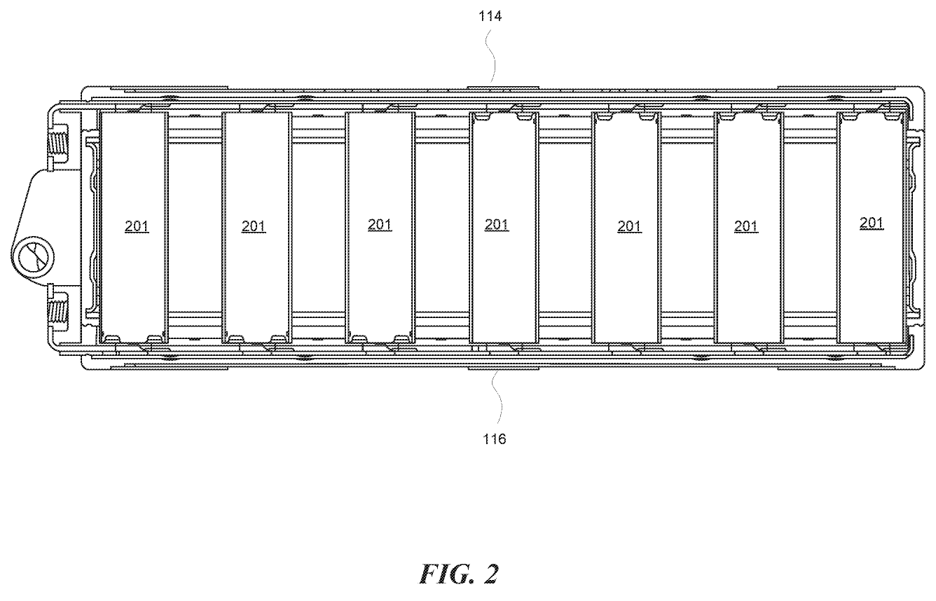

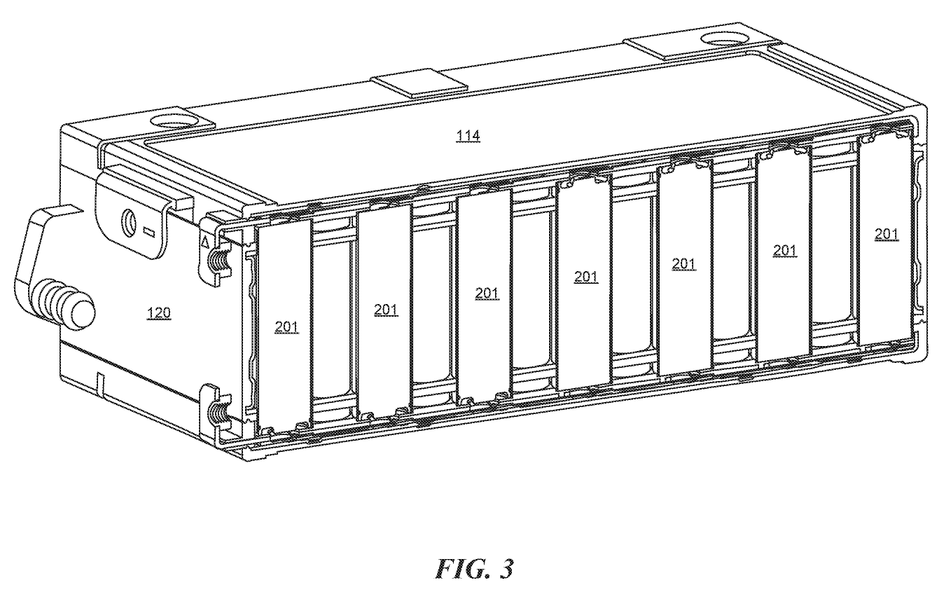

FIG. 2 shows a cross-sectional view of a battery module 200 (e.g., the battery module 100), exposing internal components of the battery module 200. FIG. 3 shows a perspective cross-sectional view of the battery module 100. The battery module 100 includes the top cover 114, the bottom cover 116, a plurality of cells 201, and a plurality of layers extending across an upper portion and a bottom portion of the battery module 100.

A plurality of cells 201 are arranged within the battery module 200. The cells 201 can be configured with various designs, such as, for example, cylindrical cell, button cell, prismatic cell, and pouch cell. Arrangements of cells with the battery module can vary by cell design and/or packing characteristics. For example, cylindrical cells can be arranged in parallel rows and columns. In another example, cylindrical cells can be arranged in staggered rows. In another example, prismatic cells can be arranged in parallel rows. An upper portion of each cell can be adjacent to a bottom portion of the top cover 114. A bottom portion of each cell can be adjacent to an upper portion of bottom cover 116.

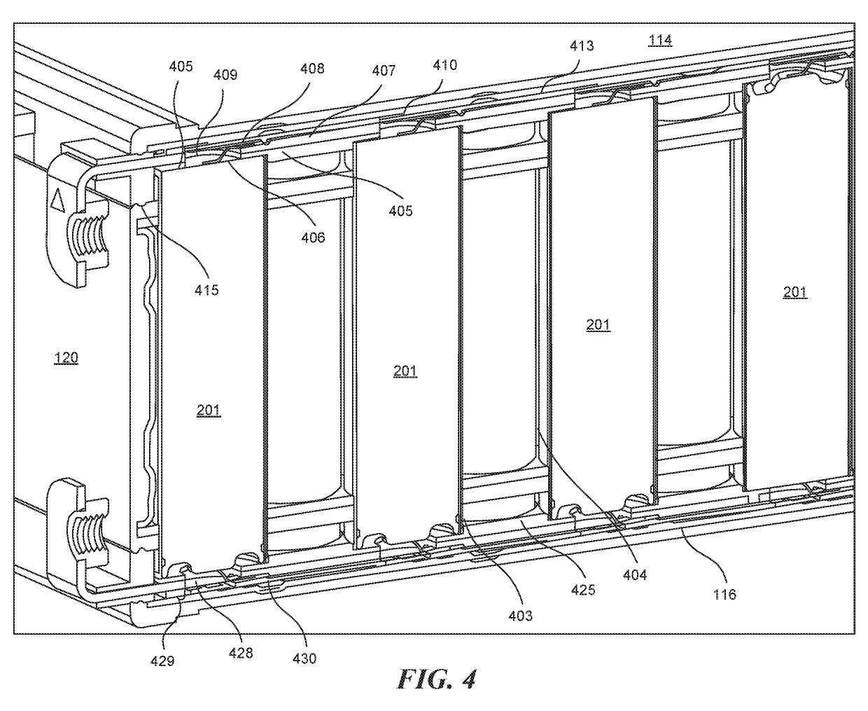

The plurality of layers extending across an upper portion of the battery module 100 can include an insulation film, a first insulation layer, a bus bar, and a second insulation layer. An opening extends from an upper surface of the plurality of cells through the first insulation layer and the bus bar up to the second insulation layer. The second insulation layer includes a perforated region which can create an opening into a channel in the event of a cell explosion. The channel extends between the second insulation layer and the top cover 114. Exploding material is directed up the opening, through the perforation in the second insulation layer, through the channel, and out a fracturable or flexible seal between the top cover 114 and the sidewall 120 of the battery module 100. Control of a direction of exploding material is achieved by directing the exploding material down the channel and out the fracturable or flexible seal, which can be used to direct exploding material away from passengers of an electric vehicle. The plurality of layers within the battery module 100 are discussed further below with respect to FIGS. 4-6.

FIG. 4 shows an enlarged perspective cross-section view of a portion of the battery module 100. The battery module 100 includes the plurality of cells 201 arranged within the battery module 100. The battery module 100 includes a plurality of layers (e.g., insulation layer 405, bus bar 407, and insulation layer 410 configured to direct exploding material released from a cell among the plurality of cells 201 away from other battery cells in the battery module 100.

The plurality of cells 201 can be insulated with an insulation film such as polyester or silicone rubber liner. In a liquid cooled battery module, cells can be further enclosed by or partially in contact with a metallic tube 403 or structure that conducts the heat generated from the battery cell and removed from the cell via a coolant fluid 404 in between metallic tubes or by contact with the structure by convection. The removal or addition of heat to keep the battery cell within a temperature range depends on the operating conditions of the cell and is controlled by a Battery Management System (BMS) and/or the Thermal System Controller (TSC). The Thermal System refers to the heater, cooler and/or radiator that modulates the temperature and flow rate of the coolant to achieve a certain battery cell temperature based on the heat dissipation of the battery cells and the temperature of the environment. The insulation film is in line with the pole surface of the cell and is in contact with an insulation layer 405 (e.g., silicone rubber sheet or plate) with an opening 406 around a pole of the cell. The opening 406 allows the pole of the cell to be connected to a bus bar 407 that groups the cells in parallel or series connection via a connection wire 408 that also acts as a fuse wire to conduct the electricity from the cell to the circuit. The bus bar 407 can be composed of any electrically conductive material, such as, for example, copper, gold, aluminum, silver, another metal, or a combination thereof.

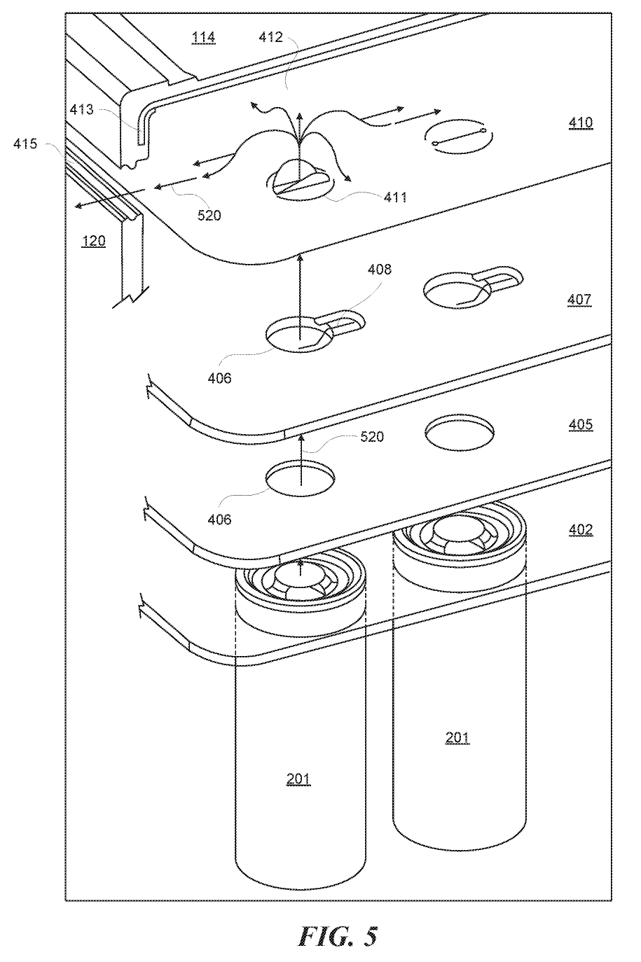

A hole on the bus bar 407 (i.e. opening 409), hole on the insulation layer 405 (i.e. opening 406), the insulation film at an end of a cell (e.g., a pole of the cell) form an enclosure that can direct hot gases and/or explosion emissions toward a perforated region 411 (FIG. 5) of an insulation layer 410. The emission of hot gaseous fumes is the precursor to an explosion of a cell. The insulation layer 410 is on top of the bus bar 407. The insulation layer 410 can be composed of, for example, silicone rubber. The insulation layer 410 has a perforated region 411 over the opening 406 of the insulation layer 405 and the opening 409 of the bus bar 407. The insulation layer 410 can include a plurality of perforated regions similar or identical to perforated region 411, in line with poles of the plurality of cells 201. The perforated region 411 can include a slit or multiple slits extending partially or completely through the insulation layer 410. Various numbers and depths of slits can be used in the perforated region 411 to tailor a fracture strength of the perforated region 411. The fracture strength of the perforated region 411 can be low enough such that a cell explosion causes the perforated region 411 to rupture. The fracture strength of the perforated region 411 can be high enough such that an explosion of a neighboring cell does not cause the perforated region 411 to rupture. Design parameters for fracture strength can include cell size and composition (e.g., a greater fracture strength based on a larger cell size, a greater fracture strength based on a more caustic composition, etc.).

On top of the perforated region 411 is a channel 412 (FIG. 5). In the event of a cell explosion rupturing the perforated region 411, the channel 412 can contain gaseous fumes and/or burning debris from a potential explosion of a cell and/or direct gaseous fumes and/or burning debris toward a fracturable or flexible seal 415. The channel 412 can be purged or filled with an inert gas (e.g., argon). On top of the insulation layer 410 is a conductive liner 413 bonded to the bottom side of a top cover 114. The conductive liner can be composed of an ablative material, such as, for example, silicone rubber. The conductive liner can be composed of a thermally conductive material, such as, for example, silicone rubber. The conductive liner 413 acts as a heat transfer conduit for transferring heat from the bus bar 407 to the top cover 114. The top cover 114 can act as a heat sink for the bus bar 407.

FIG. 5 shows the top cover construction and the flow of the gaseous fumes and debris, escaping through the fracturable or flexible seal 415 (e.g., a flexible silicone lip seal) at the interface between the top cover 114 and the sidewall 120 of the battery module 100.

In an instance where the cell explodes, explosion emissions 520 (e.g., gaseous fumes and burning debris) are ejected through the perforated region 411 of the insulation layer 410 (e.g., a silicone sheet). The explosion emissions 520 hit the conductive liner 413 and are deflected down the channel 412. The insulation layer 410 (e.g., silicone rubber) around the perforated region 411 prevents the explosion emissions 520 from entering and touching other neighboring cells. Since other perforated region(s) (e.g., perforated regions comparable to the perforated region 411 above other battery cells) have not been split open from an exploding battery cell, the other perforated region(s) remain sealed, thus preventing explosion emissions 520 in the channel 412 from contacting the other cells. The channel 412 (e.g., including argon gas) deprives the explosion emissions 520 of oxygen and thus decrease combustion of the explosion emissions 520. The insulation layer 410 also prevents explosion emissions 520 from starting a fire or flame since it is an ablative material (e.g., silicone rubber) that only chars and does not burn. Further, the debris of the explosion emissions 520 get absorbed or embedded into the material of the insulation layer, preventing explosion emissions 520 from contacting and igniting neighboring cells.

The top cover 114 is attached to the sidewall 120 of the battery module 100 by the fracturable or flexible seal 415. If an explosion exceeds a threshold strength of the fracturable or flexible seal 415, the fracturable or flexible seal 415 fractures outwardly, releasing the gaseous fumes and debris to the outside at the sides of the battery module. The threshold strength of the fracturable or flexible seal 415 is less than a fracture strength of other components under stress by increased pressure in the channel 412. Thus, the fracturable or flexible seal 415 can fracture before other components if explosion emissions are ejected into the channel 412. By releasing gaseous fumes and/or debris through the fracturable or flexible seal 415 (e.g., at the sides of the battery module 100), passengers above the battery module 100 are avoided.

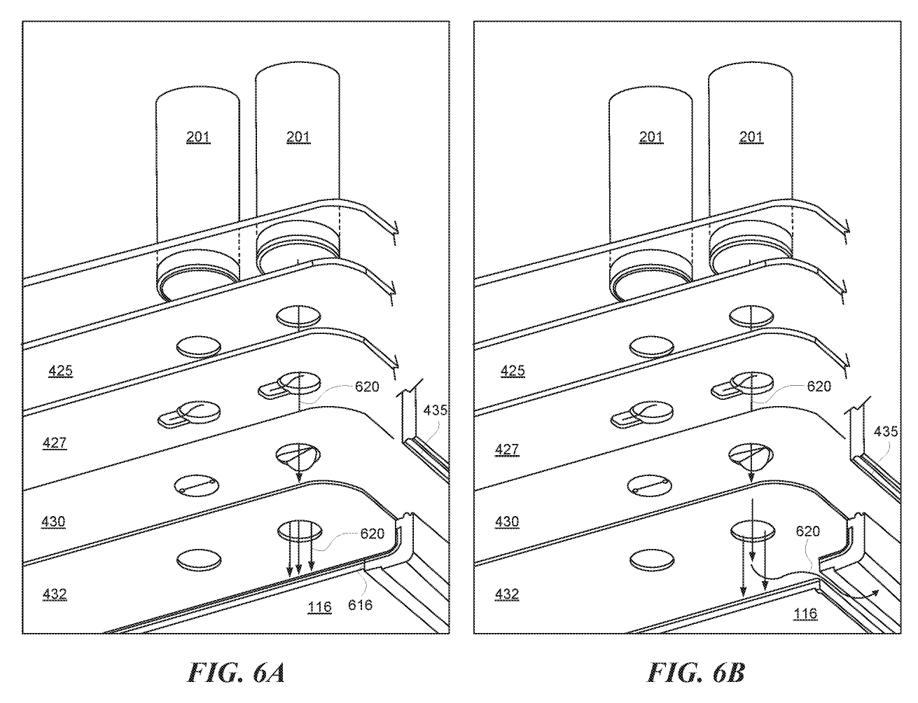

FIGS. 6A-6B show an example of the construction of the bottom cover 116 of the battery module 100. The gaseous pressure ruptures the battery module 100 at a fracture line 616 of the bottom cover 116 and/or at a fracturable or flexible seal 435 between the bottom cover 116 and a sidewall (e.g., sidewall 120), releasing explosion emissions 620 (e.g., gaseous fumes and debris) out of the battery module 100. FIG. 6A shows a rupture at the fracturable or flexible seal 435. FIG. 6B shows a rupture at the fracture line 616 and the fracturable or flexible seal 435.

Various designs for the bottom cover 116 are contemplated. For example, a design similar to the top cover design can be employed the bottom cover 116 to direct explosion emissions from a bottom of the cell 201 through the sidewall 120. In another example, a plurality of layers below the battery cells can be configured to direct the explosion emissions downward. In another example, a plurality of layers below the battery cells can be configured to direct explosion emissions downward and through a sidewall (e.g., by including a fracturable or flexible seal 435 between the bottom cover 116 and a sidewall as well as a fracture line in the bottom cover 116), as shown in FIG. 6B.

Explosion emissions can be directed through a fracture line 429 (FIG. 4) at a bottom of the battery module 100. An insulation layer 425 (e.g., a silicone plate) includes an opening below a pole of any of the plurality of cells 201. A bus bar 427 includes an opening in line with the opening of the insulation layer 425. A connection wire 428 connects the bus bar 427 to a pole of the cell. The opening of the insulation layer 425 and the opening of the bus bar 427 together form an opening extending from a pole of the cell to the bottom cover 116. An insulation layer 430 includes a perforated region in line with the opening of the insulation layer 425 and the opening of the bus bar 427. Another insulation layer 432 can be included below insulation layer 425. Insulation layer 432 includes an opening in line with the opening of the insulation layer 425 and the opening of the bus bar 427. A channel below the insulation layer 430 (and below the insulation layer 432 if included) extends from the perforated region of the insulation layer 430 to the fracture line 429 in the bottom cover 116.

The force of an explosion acts on the bottom cover 116 of the module. The bottom cover 116 includes a fracture line 429. If a battery cell explodes downward, fumes and debris can be constrained by the opening of the insulation layer 425 and the opening of the bus bar 427 unless a force of the explosion exceeds a fracture strength of the fracture line 429. The fracture line 429 of the bottom cover 116 ruptures if the force of an explosion of a cell exceeds a threshold strength of the fracture line 429. When the fracture line 429 of the bottom cover 116 ruptures, explosion emissions are directed through the ruptured fracture line 429.

The fracture line 429 has a fracture strength lower than the fracture strength of the bottom cover 116. For example, the fracture strength of the fracture line 429 can range from approximately 20% to approximately 80% of the fracture strength of the bottom cover 116. Since the fracture line 429 has a lower fracture strength than other portions of the bottom cover 116, a fracture is more likely to occur at the fracture line 429 than at other regions in the bottom cover 116. The fracture line 429 is located adjacent to the opening extending through the insulation layer 425 and the bus bar 427 so an explosive force from a cell can cause the fracture line 429 to fracture and provide a pathway for explosion emissions to exit the battery module 100 in a downward direction (e.g., away from passengers of a vehicle).

Hence, the techniques introduced here alleviate cell explosion propagation in the battery module 100. Embodiments involve directing explosion emissions from a top of a cell down a channel 412 and out a fracturable or flexible seal 415. An opening 406 extends from a pole on top of a cell to the perforated region 411 of the insulation layer 410. On an opposite side of the insulation layer 410 as the opening 406, the channel 412 extends from the perforated region 411 to the fracturable or flexible seal 415. If a cell explodes, the perforated region 411 opens into the channel 412. If a cell explosion causes a force exceeding a fracture threshold of the fracturable or flexible seal 415, the fracturable or flexible seal 415 ruptures and/or deflects outward, releasing explosion emissions out of the battery module 100.

Embodiments involve directing explosion emission from a bottom of a cell down an opening and out a fracture line 429 of the bottom cover 116 and/or out the fracturable or flexible seal 435 between the bottom cover 116 and a sidewall of the battery module 100. Embodiments include redundancy of any of the components, including additional fracture lines and fracturable or flexible seals. An opening extends from a pole on a bottom of a cell to a perforated region of the insulation layer 430. On an opposite side of the insulation layer 430 as the opening, a channel extends from the perforated region to the fracture line 429 and/or the fracturable or flexible seal 435. If a cell explosion causes a force exceeding a fracture threshold of the fracture line 429, the fracture line 429 ruptures and/or deflects outward, releasing explosion emissions out of the battery module 100. Similarly, if a cell explosion causes a force exceeding a fracture threshold of the fracturable or flexible seal 435, the fracturable or flexible seal 435 ruptures and/or deflects outward, releasing explosion emissions out of the battery module 100. If both the fracture line 429 and the fracturable or flexible seal 435 are included in the battery module 100, either or both can fracture in the event of an explosion. The fracture strength of the fracture line 429 and the fracturable or flexible seal 435 can be adjusted, resulting in either fracturing first or simultaneous fracture. Including both the fracture line 429 and the fracturable or flexible seal 435 ensures that explosion emissions are directed away from neighboring cells even if one (either fracture line 429 or the fracturable or flexible seal 435) fails to fracture at a designed threshold.

What is claimed is:

1. A battery module comprising:
a plurality of cells within an enclosure formed by a top cover, a bottom cover, and at least one sidewall;
an insulation layer having a perforated region;
an opening extending from a pole of at least one cell of the plurality of cells to the perforated region of the insulation layer; and
a channel on an opposite side of the insulation layer as the opening, the channel extending from the perforated region to a fracturable seal or a flexible seal between the top cover and the at least one sidewall.

2. The battery module of claim 1, wherein the perforated region has a lower fracture strength than an adjacent portion of the insulation layer.

3. The battery module of claim 1, wherein the fracturable seal has a lower fracture strength than the top cover.

4. The battery module of claim 1, wherein the channel is filled with an inert gas and lined with an ablative material.

5. The battery module of claim 1, wherein the opening is filled with an inert gas and lined with an ablative material.

6. The battery module of claim 1, further comprising:
another insulation layer on an upper surface of the at least one cell; and
a bus bar on an upper surface of the another insulation layer, the bus bar having a connection wire in contact with the pole of the at least one cell;
wherein the opening extends through the another insulation layer and the bus bar.

7. The battery module of claim 6, wherein the bus bar is composed of a metal.

8. The battery module of claim 1, wherein the insulation layer is composed of silicone rubber.

9. The battery module of claim 1, further comprising:
another opening extending from a lower pole of the at least one cell to another perforated region of another insulation layer; and
another channel on an opposite side of the another insulation layer as the opening.

10. The battery module of claim 9, wherein the another channel extends from the another perforated region to a fracture line in the bottom cover.

11. The battery module of claim 10, wherein a fracture strength of the fracture line is less than a fracture strength of an adjacent portion of the bottom cover.

12. The battery module of claim 9, wherein the another channel extends from the another perforated region to another fracturable or flexible seal between the bottom cover and the at least one sidewall.

13. The battery module of claim 9, further comprising:
another insulation layer on a lower surface of the at least one cell;
another bus bar on a lower surface of the another insulation layer, the another bus bar having another connection wire in contact with the lower pole of the at least one cell;
wherein the another opening extends through the another insulation layer and the another bus bar.

14. The battery module of claim 1, wherein each cell of the plurality of cells is encased in an insulation film.

15. The battery module of claim 1, wherein the insulation layer includes a plurality of perforated regions, wherein a plurality of openings extend from a plurality of poles of the plurality of cells to the plurality of perforated regions.

16. A battery module comprising:
a plurality of cells within an enclosure formed by a top cover, a bottom cover, and at least one sidewall;
an opening extending from a lower pole of at least one cell of the plurality of cells to a perforated region of an insulation layer; and
a channel on an opposite side of the insulation layer as the opening extending from the perforated region to a fracture line of the bottom cover.

17. The battery module of claim 16, wherein the channel extends from the perforated region to a fracturable seal or a flexible seal between the bottom cover and the at least one sidewall.

18. The battery module of claim 16, further comprising:
another insulation layer on a lower surface of the at least one cell;
a bus bar on a lower surface of the another insulation layer, the bus bar having a connection wire in contact with the lower pole of the at least one cell;
wherein the opening extends through the another insulation layer and the bus bar.

19. A battery module comprising:
a plurality of cells encased by an enclosure including a top cover and a sidewall;
a first insulation layer on the plurality of cells;
a bus bar on the first insulation layer;
a second insulation layer on the bus bar having a plurality of perforated regions in line with poles of the plurality of cells, wherein a plurality of openings extend from a surface of the plurality of cells through the first insulation layer and the bus bar to the plurality of perforated regions;
a channel between the second insulation layer and the top cover extending from the plurality of perforated regions to a fracturable seal or a flexible seal between the top cover and the sidewall.

20. The battery module of claim 19, wherein the plurality of perforated regions have a lower fracture strength than adjacent portions of the second insulation layer.

21. The battery module of claim 19, wherein a perforated region among the plurality of perforated regions is configured to rupture if a cell among the plurality of cells in line with the perforated region explodes.

22. The battery module of claim 19, wherein an exploding cell among the plurality of cells ruptures a perforated region in line with the exploding cell without rupturing other perforated regions of the plurality of perforated regions.

23. The battery module of claim 19, wherein an exploding cell among the plurality of cells ruptures a perforated region in line with the exploding cell and either ruptures the fracturable seal or deflects the flexible seal outward.

24. A battery module comprising:
a plurality of cells encased by an enclosure including a bottom cover and a sidewall;
a first insulation layer on the plurality of cells;
a bus bar on the first insulation layer;
a second insulation layer on the bus bar having a plurality of perforated regions in line with poles of the plurality of cells, wherein a plurality of openings extend from a surface of the plurality of cells through the first insulation layer and the bus bar to the plurality of perforated regions;
a channel between the second insulation layer and the bottom cover extending from the plurality of perforated regions to a fracture line of the bottom cover.

25. The battery module of claim 24, wherein an exploding cell among the plurality of cells ruptures a perforated region in line with the exploding cell without rupturing other perforated regions of the plurality of perforated regions.

26. The battery module of claim 24, wherein an exploding cell among the plurality of cells ruptures a perforated region in line with the exploding cell and ruptures the fracture line of the bottom cover.
